(19) United States
(12) Patent Application Publication
(10) Pub. No.: US 2016/0367915 A1
(43) Pub. Date: Dec. 22, 2016

(54) System and Method For Recapturing and Cleaning Fluid

(71) Applicants: Jeff Wayne Melnyk, Airdrie (CA); Thomas Alan Kissick, Peace River (CA)

(72) Inventors: Jeff Wayne Melnyk, Airdrie (CA); Thomas Alan Kissick, Peace River (CA)

(21) Appl. No.: 15/187,754

(22) Filed: Jun. 20, 2016

Related U.S. Application Data
(60) Provisional application No. 62/182,481, filed on Jun. 20, 2015.

(51) Int. Cl. B01D 21/26; B01D 21/30; B01D 21/00; B01D 21/34

(52) U.S. Cl. CPC B01D 21/262; B01D 21/34; B01D 21/302; B01D 21/009

(57) ABSTRACT

In one aspect there is provided a system for cleaning a slurry contaminated with solids. The system comprises a vertical cuttings dryer, a first tank, a second tank, a first centrifuge, a second centrifuge, a first manifold and a second manifold. Flow of the slurry through the system is controlled via the first and second manifolds. The vertical cuttings dryer, the first centrifuge and the second centrifuge are selectively employed by the system to remove solids from the slurry. The first tank is selectively employed by the system to hold or treat the slurry. The second tank is employed by the system to hold the resulting treated and cleaned slurry.

### CROSS REFERENCE TO RELATED APPLICATION

This application is a regular application of U.S. Provisional Patent Application Ser. No. 62/182,481 filed Jun. 20, 2015 and entitled, “A System and Method For Recapturing and Cleaning Fluid”, the entirety of which is incorporated herein by reference.

### FIELD OF THE INVENTION

The present invention relates to a system and method for remediating earthen particulates and to cleaning industrial fluids. More particularly, the present invention relates to a system and method that recaptures drill cuttings and which cleans drilling fluid of solid contaminants within that fluid.

### BACKGROUND OF THE INVENTION

Oil and gas servicing operations require fluid for a variety of reasons, most commonly during drilling and completions operations. The fluid may be used in drilling operations for lubricating the borehole, cleaning away cuttings, and maintaining control of the well by overcoming the reservoir pressure. In completion operations, fluid is generally used for stimulating the formation, such as by acidizing or fracturing, cleaning the well bore, and maintaining well control. In most cases the amount of fluid required is large and the fluid must be prepared and stored onsite during the operation, and disposed of properly once no longer usable.

In drilling operations, the fluid brought up from the well bore is mixed with cuttings from the drilling process and other potential solid contaminants. In this state it cannot be reused as part of the well servicing operations.

In an effort to recover the fluid from the fluid-solid mix, it is standard practice on a well site for used drilling fluid to be transferred directly to a ‘shaker’. The shaker is a machine that uses vibration and fine screens to separate out fluid which is then stored in tanks to be re-used in the drilling process, albeit with decreased performance due to micro-solids still present in the used fluid. A by-product of the shaker process is a semi-dry sludge consisting of cuttings that are still coated with the fluid that was not recovered during the shaking process. The semi-dry sludge by-product is typically mixed with an absorbent and stabilizer, usually sawdust based, before it can be safely hauled away via truck to a landfill or other appropriately designated waste facility. Depending on the type of drilling fluid used, and the amount of fluid remaining mixed with the cuttings, the negative environmental consequence of creating a lot of this waste can be significant. Furthermore, the loss of excess fluid has negative economic consequences for companies purchasing the fluid.

There is a demonstrated need in the oil & gas industry for improved onsite recapturing and cleaning systems and methods for extracting excess fluid from cuttings off of well drilling and servicing operations. Likewise there is a need in other industries, where fluid is used and becomes contaminated to be captured and cleaned for reuse. There is also a broad need for improved onsite recapturing and cleaning systems and methods for extracting excess fluid in other industries as well, such as recapturing fluid from spills.

### SUMMARY OF THE INVENTION

In a preferred aspect the invention provides a system for cleaning a first slurry contaminated with solids. The system comprises a vertical cuttings dryer for removing at least some solids from the first slurry and generating a second slurry. The system further comprises a first tank for accepting the second slurry and for treating said second slurry to generate a third slurry. A first centrifuge is provided for accepting the third slurry, for removing some solids from said third slurry and for generating a fourth slurry. A second centrifuge is also provided for accepting the third slurry, for removing some solids from said third slurry and for generating a fifth slurry. The system preferably further comprises a second tank for accepting the third slurry, a first manifold for accepting the third slurry from the first tank and directing said third slurry to one or more of the first centrifuge, the second centrifuge or the second tank, and a second manifold for accepting one or both of the fourth slurry from the first centrifuge, or the fifth slurry from the second centrifuge.

### BRIEF DESCRIPTION OF THE DRAWINGS

Referring to the drawings, several aspects of the present invention are illustrated by way of example, and not by way of limitation, in detail in the figures, wherein:

FIG. 1 is a schematic of a first embodiment of a fluid recapturing and cleaning system of the present invention;

FIG. 2 is a schematic of a second embodiment of a fluid recapturing and cleaning system of the present invention;

FIG. 3 is a schematic of a third embodiment of a fluid recapturing and cleaning system of the present invention;

FIG. 4 is an exploded isometric view of a fourth embodiment of a fluid recapturing and cleaning system of the present invention, shown mounted on a truck;

FIG. 5 is an isometric view of the system of FIG. 4; and

FIG. 6 is an isometric view of the system of FIG. 4.

### DESCRIPTION

The following description is of preferred embodiments by way of example only and without limitation to the combination of features necessary for carrying the invention into effect. Reference is to be had to the Figures in which identical reference numbers identify similar components. The drawing figures are not necessarily to scale and certain features are shown in schematic or diagrammatic form in the interest of clarity and conciseness.

Various embodiments of a fluid recapturing and cleaning system 100 and method are disclosed herein. The fluid recapturing and cleaning system 100 is preferably mounted on a truck T. Advantageously, such a truck-mounted system can be easily deployed to various industrial sites. However, in alternative embodiments, certain components may be mounted on different trucks, or transported separately and placed near the system 100 on rig mats or the ground.

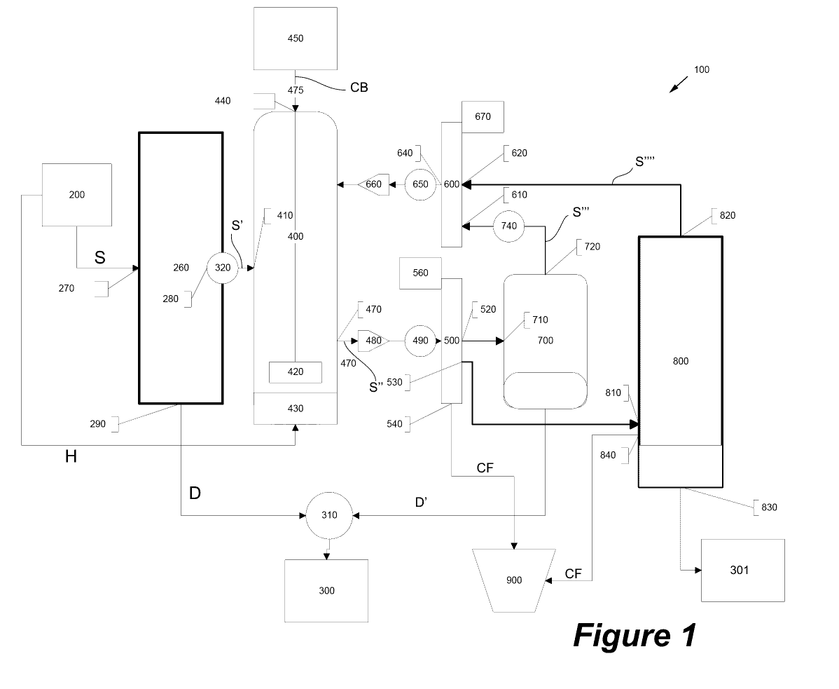

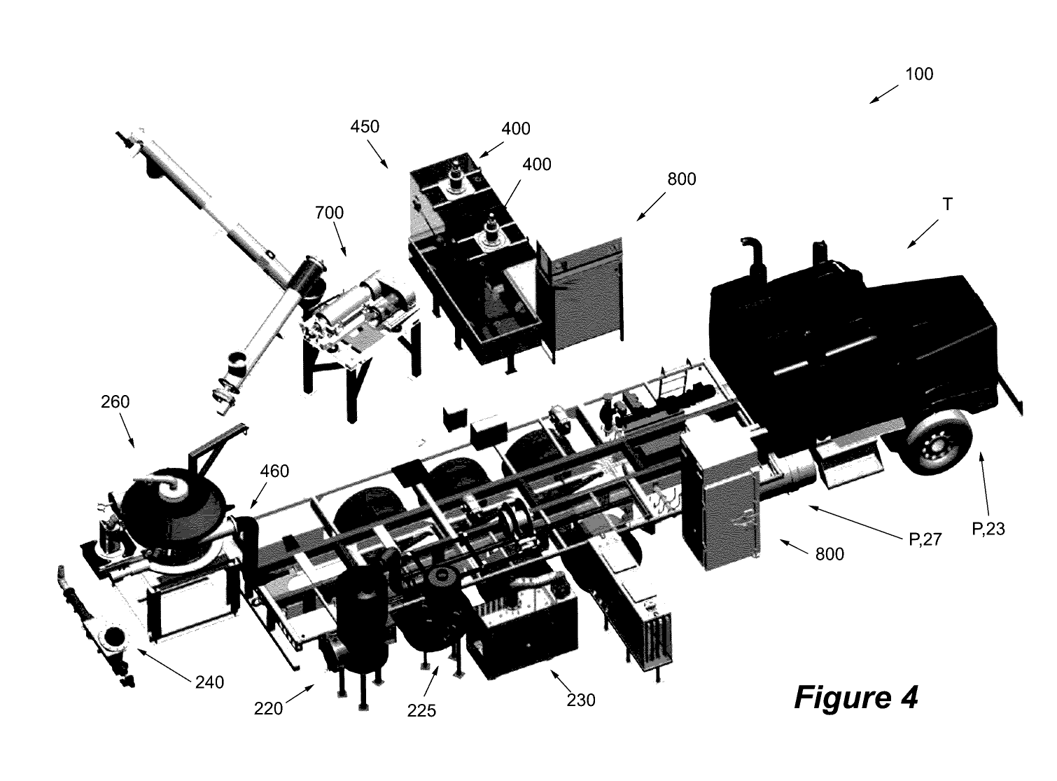

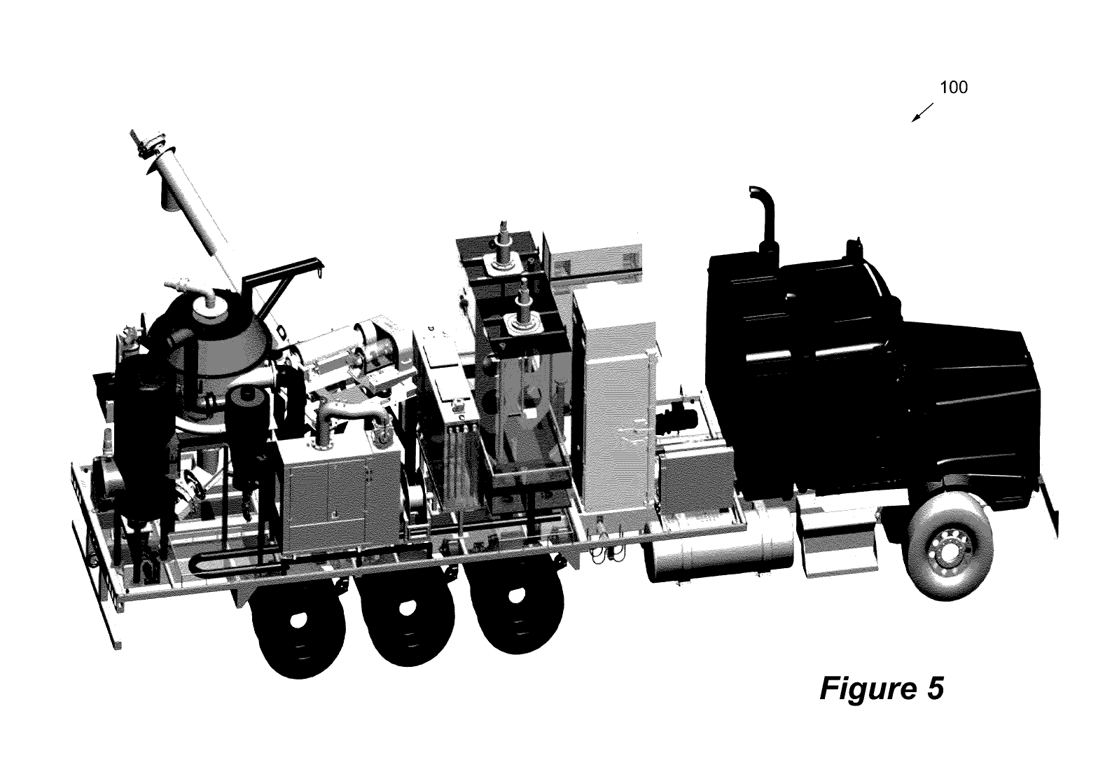

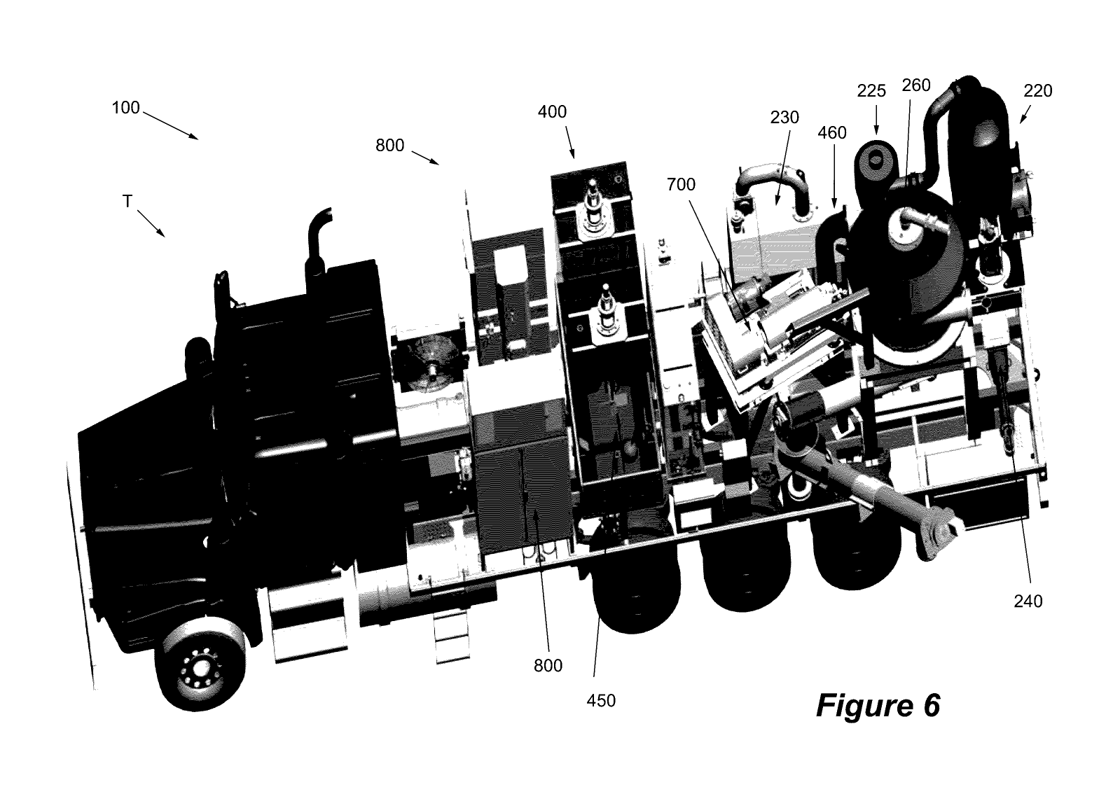

Having reference to FIGS. 1-3, a schematic diagram is provided showing three different embodiments of a fluid recapturing and cleaning system 100 of the present invention. Having reference to FIGS. 4-6, isometric views of a fourth embodiment of the system 100, shown mounted on a truck T, are provided. These various embodiments are very similar, differing only in how contaminated fluid, or a first slurry S, may be delivered into the vertical cuttings dryer 260 (as further described below) and/or whether the system 100 is shown mounted on a truck T.

In each of the embodiments, a conventional power source P is preferably provided for the fluid recapturing and cleaning system 100. This power source P may comprise a fuel tank 27 and a power unit 23. The fuel tank 27 may be part of a truck's existing fuel system, if the recapturing and cleaning system is placed on a truck, or as a separate tank. The power unit 23, in one embodiment may be the truck's engine if the recapturing and cleaning system is placed on a truck T, or it may be a power generator. The power may be sized to properly power all the system's components, and furthermore be capable of performing any power conversion needed by any of the individual components.

The fluid recapturing and cleaning system 100 preferably provides a three phase process to treat contaminated fluid (such as drilling mud contaminated with drill cuttings). Such contaminated fluid may also be referred to as a slurry S. The three phase process may be applied to recapturing and cleaning fluid or slurry S that is either oil based or water based. In the scenario where water based fluid is being treated, the system can be altered to include insulation and heating as necessary to assist in the prevention of freezing when the external ambient environment reaches sub-freezing temperatures.

### First Phase Separation

Having reference to the Figures, the first phase of the fluid recapturing and cleaning system 100 receives very thick, highly dense slurry S, such as drilling mud saturated with drill cuttings from oil and gas well drilling operations.

In these embodiments, the first phase separation aspect preferably comprises vertical cuttings dryer 260 having a slurry inlet 270, a slurry outlet 280 and a first solids outlet 290. During operations, vertical cuttings dryer 260 separates most of the solid contaminants (such as drill cuttings) from typical slurries S that may be present in the oil & gas industry. A suitable vertical cuttings dryer 260, that may be mounted on a truck T, is model WSM-05 from Elgin Equipment Group of Downers Grove, Ill., U.S.A. Such a vertical cuttings dryer is able to treat contaminated slurry S on a continuous basis, where solids D are separated from the slurry S almost immediately. The model WSM-05 vertical cuttings dryer 260 has a maximum input rate of 383 liters/minute (range of slurry S treatment rate then being 0 to 383 LPM). The inventors have found that, for the system 100, an optimal input rate of contaminated slurry S into the vertical cuttings dryer 260 is generally at around 200 LPM.

As noted above, FIGS. 1-3 illustrate embodiments of the system 100 that primarily differ in how contaminated fluid or slurry S may be delivered into the vertical cuttings dryer 260.

In the embodiment of FIG. 1, a first slurry transporting apparatus 200 is provided for accepting the slurry from the industrial source (such as an oil and gas rig or other industrial process), and transporting it into the vertical cuttings dryer 260. In one embodiment, the slurry moving apparatus 200 may comprise a slurry pump, such as a concrete pump (not shown) having a hopper (not shown) attached to the inlet of the slurry pump for accepting the slurry S and for transporting the slurry S into the vertical cuttings dryer 260. A suitable concrete pump is a REED A30HP concrete pump, which may be provided on a stand-alone trailer with a self-contained power source.

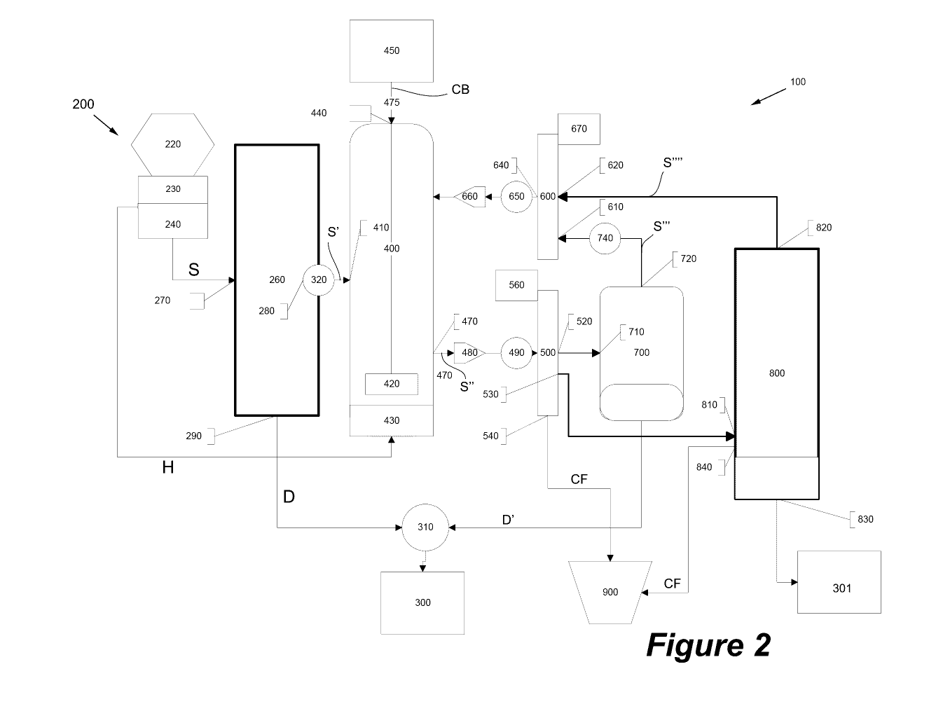

In the embodiment of FIG. 2, the first phase slurry transporting apparatus 200 may comprise a cyclone cylinder 220 having a vacuum pump 230 attached thereto for accepting the first phase slurry S. A suitable vacuum pump 230, for mounting on a truck T, is a Hibon vacuum pump model #VTB820XL. The cyclone cylinder 220 may be manufactured by Stewart and Stevenson, and may be provided with a cyclone cylinder overflow protection apparatus 225, also manufactured by Stewart and Stevenson; both being suitable for mounting on a truck T.

The vacuum generated by the vacuum pump 230 sucks the slurry S into the cyclone cylinder 220 where the liquid and solids elements of the slurry S drop to the bottom due to gravity and then into the inlet of a cuttings pump 240. The cuttings pump 240 then moves the slurry S into the vertical cuttings dryer 260. A suitable cuttings pump 240, for mounting on a truck T, is a progressive cavity cuttings pump, model #W15B by Mono.

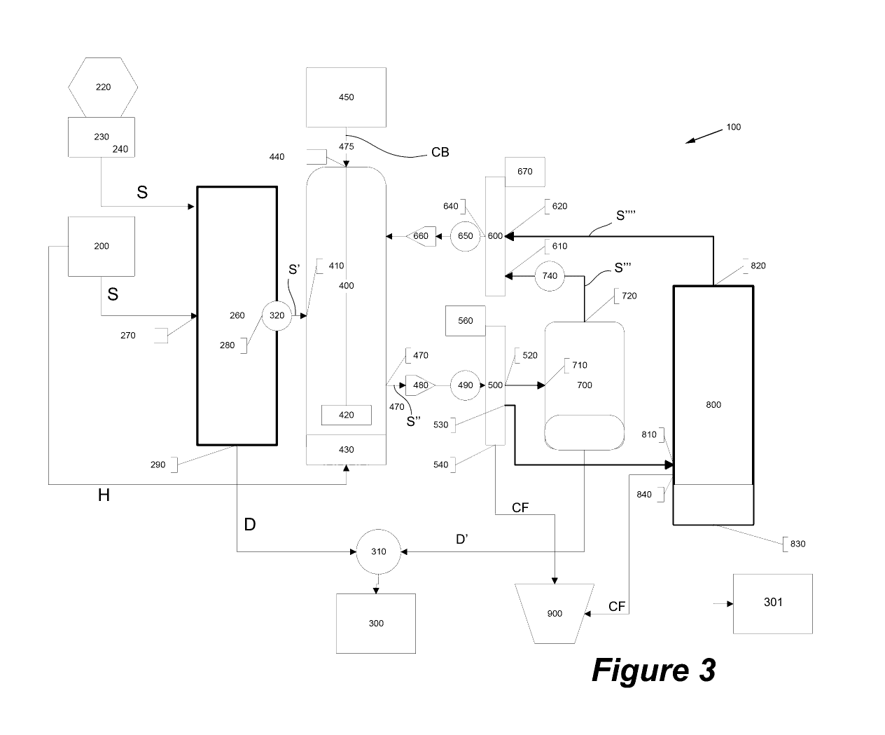

In the embodiment of FIG. 3, the first slurry transporting apparatus 200 comprises both: (i) the slurry pump and the hopper as described above for the embodiment of FIG. 1, and (ii) the cyclone cylinder 220 vacuum pump 230 and cuttings pump 240 as described above for the embodiment of FIG. 2. In this embodiment, it is anticipated that the slurry S will be primarily transported by the slurry pump and the hopper. The cyclone cylinder 220 and vacuum 230, however, provide and additional utility function, i.e. wherein the cyclone cylinder 220 and vacuum 230 may be used to clean up spills, assist in unplugging the system 100, and/or assist in back flushing the lines of the system 100 for cleaning.

The rate at which the first slurry transporting apparatus 200 feeds the vertical cuttings dryer 260 is dependent on many factors, such as the needs of the industrial process or drilling rig operations, the capacity of the elements of the fluid recapturing and cleaning system 100 and the composition of the slurry S. The rate may be controlled manually or automatically with predetermined criteria and controls.

The vertical cutting dryer 260 separates the majority of the solids D from the slurry S through a natural settling process wherein the solids accumulate at the bottom of the vertical cuttings dryer 260. These solids D may be removed and disposed in accordance with industry practice. The vertical cuttings dryer, 260, can be that of industry standard technology, and should be capable of removing 90-95% of the solids from a slurry S containing drill cuttings from drilling rig operations as an example. Preferably, a waste bin 300 is provided for the collection of the settled solids D. The settled solids D may be transported to the waste bin 300 manually or via a solids moving apparatus 310 such as a screw conveyor or the like as is known in the art. These solids D produced by the system 100 (primarily drill cuttings) are typically dry to the touch, stackable, and at times ‘dusty’ depending on the make up of the cuttings. The inventors have tested samples of such solids D produced by the system and, on average (by volume), are 88-93% solids and 7-12% liquids (oil/water).

The remaining fluid from the vertical cuttings dryer 260 is recaptured fluid where fine solids containments may still be present. This fluid may be referred to as second slurry S′, is often very high in LGS's (low gravity solids) and, therefore, not suitable for reintroduction to the drilling fluid system on a rig until it has been further treated by the system 100. As such, this slurry S′ is preferably removed from the vertical cuttings dryer 260 through the slurry outlet 280 by a second slurry moving apparatus 320. The second slurry moving apparatus 320 may be a pump to direct said slurry S′ the second phase of the fluid recapturing and cleaning system 100 process.

### Second Phase Separation

Having reference to the Figures, an embodiment of a second phase separation of the system 100 are provided herein. The second phase separation receives the second slurry S′ from the vertical cuttings dryer 260 of the first phase separation and removes additional finer solids from that slurry S′.

The second phase separation preferably comprises a holding tank 400 having a slurry inlet 410 fluidly connected to the outlet of the second slurry moving apparatus 320, an impeller or paddle 420 located near the bottom of and within the holding tank 400, for mixing or agitating the slurry S′ therewithin. A suitable agitator impeller or paddle 420 is a Zazula top drive paddle style agitator. The holding tank 400 may therefore also be referred to as an agitator tank 400 or a first tank. Additional tanks may also be provided in the system 100, including a second tank to accept the treated slurry as clean fluid CF and a third tank hold clean base fluid CB to inject into the system 100 as further described below.

A heating plate 430 is preferably provided externally and in contact with the agitator tank 400 for heating the second slurry S′ therein to an optimum temperature for separating solids from the slurry downstream. In certain embodiments (e.g. FIG. 2) the exhaust from the vacuum pump 230 may be fluidly connected to the heating plate 430 for transferring heat H from the vacuum 230 exhaust to the heating plate 430. The inventors have observed heat H coming off of the vacuum 230 in the form of approximately 160 degree F. hot air at 1660 cfm (2823 m3/hr).

The more heat H that is applied to the second slurry S′, the less viscosity it becomes and the more effective subsequent downstream separation becomes in the system 100. Although the system 100 will still work without the addition of heat H, including when slurry S′ temperatures are below 0 degrees C. (e.g. oil-based slurry S′), it is generally desirable to have the second slurry S′ at a temperature of 20 degrees C. to 40 degrees C. However, since higher temperatures may become a safety concern to any operators of the system 100, the 40 degrees C. is a preferred upper range for the temperature of the second slurry S′.

Preferably a clean base inlet 440 is provided within the agitator tank 400 and fluidly connected to a clean base fluid holding tank 450 for providing a clean base fluid CB to the agitator 400, as may desired during separation operations. Clean base fluid tank 450 may also be referred to as the third tank 450. A suitable sized clean base holding tank 450, for mouting on a truck, is 3.8 m³. The consistency of slurry S′ from the vertical cuttings dryer 260 may have a density as high at 2000 kgs/m3 and a consistency of pudding. As such the clean base fluid CB may be required to achieve a more favourable (e.g. lower) density of the slurry prior to moving downstream and/or to maintain sufficient circulation in the system.

A feedback inlet 460 is preferably provided to tank 400 for accepting various slurry mixtures (e.g. slurry S′″) from downstream operations, to mix/remix with second slurry S′ from the vertical cuttings dryer 260. A slurry outlet 470 is preferably provided to tank 400 for the removal of a treated slurry S′ (e.g. heated, agitated and/or diluted slurry S′) from the agitator 400.

As such, agitator tank 400 may function as a holding tank to hold a quantity of second slurry S′, as an agitator tank to agitate the second slurry S′ (to minimize settling of solids within said tank 400), as a dilution tank to dilute the second slurry S′ with clean base fluid, as a mixing tank to mix second slurry S′ with other downstream slurries (e.g. S′″), and as a heating tank to heat said slurry S′ to a desired temperature.

Upon exiting through the slurry outlet 470 of the agitator 400, the treated slurry (e.g. mixed, heated, diluted or agitated slurry, and which may now be referred to as a third slurry S″) preferably flows through a first flow meter/densitometer 480 which preferably measures both the density of the third slurry S″ and the rate at which it flows. This information may be used by the system 100, and/or an operator of the system 100, to make adjustments to the system, including as described below. A suitable flow meter/densitometer 480 is an Endress and Hauser Proline Promass 83F Flowmeter.

Preferably, a third slurry moving apparatus 490, such as a screw pump, is provided for displacing the slurry S″ from the agitator tank 400. Moving apparatus 490 may be located upstream or downstream of the first flow meter/densitometer 480.

Preferably, a first manifold 500 is provided and located downstream of the first flow meter/densitometer 480 and the third fluid moving apparatus 490. The first manifold 500 preferably comprises an inlet 510 for accepting the slurry S″ therein and multiple outlets. In the present embodiment, the first manifold 500 comprises a first outlet 520, a second outlet 530, and a third outlet 540. The fluid flow of the third slurry S″ through the first manifold 500 is preferably controlled either manually or by a first conventional controller 560.

The first controller 560 preferably comprises a computer processor for receiving input data (e.g. from the first flow meter/densitometer 480), for computing the input data, comparing that input data to a predetermined set of criteria, and providing output instructions to the first manifold 500, e.g. for directing the flow path of the slurry S″. Upon the density of the slurry S″ being determined from the first flow meter/densitometer 480, either the first 520, second 530 or third outlet 540 of the first manifold 500 will be opened (either manually or automatically by the first controller 560). The first manifold will allow the slurry S″ to flow to a first centrifuge 700, a second centrifuge 800, or a clean fluid tank 900. Clean fluid tank 900 may also be referred to as the second tank 900. The first centrifuge 700 is preferably a decanter centrifuge, but may be any centrifuge suitable to remove solids (from a slurry) that are 8 microns or larger. The second centrifuge is preferably a dynamic settling centrifuge, but may be any centrifuge suitable to remove solids (from a slurry) that are in the 0.25 to 8 micron (or larger) size range.

The first flow meter/densitometer 480 measures the slurry, if the third slurry S″ contains solids greater than a first pre-determined condition (e.g. with solids greater than 8 microns), the first manifold 500 provides a flow path for the slurry S″ to the decanter centrifuge 700 for a pre-determined treatment cycle wherein such solids D′ are removed and the slurry (now referred to as a forth slurry S′″) is reintroduced to back into the agitator 400. If the third slurry S″ contains solids less than the first pre-determined condition (e.g. less than 8 microns) but greater than a second predetermined condition (e.g. greater than 0.25 microns), the first manifold 500 provides a flow path for the third slurry S″ to the dynamic settling centrifuge 800, for a pre-determined treatment cycle wherein solids are removed and the slurry (now referred to as a fifth slurry S″″) is reintroduced back to the agitator 400. If the third slurry S″ contains solids less than the second pre-determined condition (e.g. less than 0.25 microns), the first manifold 500 provides a flow path for the third slurry S″ to the clean fluid tank 900.

The decanter centrifuge 700 is preferably provided for separating solids from the slurry S″ that are greater than 8 to 10 micro meters in size. A suitable decanter centrifuge 700, for mounting on a truck T, is a 9″ mini decanter centrifuge GN Solids model #GNLW223vFD. The decanter centrifuge 700 preferably comprises a decanter inlet 710 fluidly connected to the first outlet 520 of the first manifold 500, a decanter fluid outlet 720, and a second solids D′ outlet 730 for the removal of solids greater than 8 to 10 micro meters in size. The operation of the decanter centrifuge 700 may be manual or automatically controlled in regards to the speed and the time. After the decanter centrifuge 700 separates solids D′ from the fluid, the solids D′ are removed through the second solids outlet 730 either manually or with the solids moving device 310 to the waste bin 300. The fluid remaining in the decanter centrifuge 700 preferably exits the decanter fluid outlet 720 powered by a fourth slurry moving apparatus 740 such as a screw pump. The decanter fluid outlet 720 is preferably fluidly connected to a first inlet 610 of a second manifold 600 further comprising, a second inlet 620, a third inlet 630 and an outlet 640. Output from the second manifold 600 is preferably directed back to the agitator tank 400 (via outlet 640).

The second manifold 600 may be controlled either manually or automatically from a second controller 670. A fifth slurry moving apparatus 650, such as a screw pump or the like, is fluidly connected to the outlet 640 and controls the flow rate of the slurry therefrom. The fifth slurry moving apparatus 650 is fluidly connected to a second flow meter/densitometer 660 for measuring the density and flow rate of the slurry. The second flow meter/densitometer 660 is fluidly connected to the feedback inlet 460 of the agitator 400 wherein the slurry is again heated and mixed prior to flowing back out of the outlet 340 and through the first flow meter/densitometer 480 to be either directed to the clean fluid tank 900 through the third outlet 540, the dynamic settling centrifuge 800 through the second outlet 530 if ultra-fine solids are required to be removed, or back through the decanter centrifuge through the first outlet 520 if solids remain in the slurry that are greater than 10 micro meters. Advantageously, second flow meter/densitometer 660 provides information about the slurry moving through the second manifold 600, so as to allow the system, or an operator of the system, to know what the fluid density will be back into agitator tank 400, and to make adjustments to the system 100 ‘on the fly’ (e.g. adjust the amount of clean base fluid CB that may be added to tank 400).

### Third Phase Separation

Having reference to the figures, the dynamic settling centrifuge 800 preferably comprises an inlet 810, a slurry outlet 820, a third solids outlet 830, and a clean fluid outlet 840. This third phase of the system 100 preferably accepts fluid with ultra-fine solid contaminants. A suitable dynamic settling centrifuge 800, for mounting on a truck T, is Evodos model C50HD

In one embodiment the third slurry S″ fluid is from the second phase separation aspect, e.g. via second outlet 530 of the first manifold 500) and preferably comprises solids less than 10 micrometers. The clean fluid outlet 840 is fluidly connected to the clean fluid tank 900 for the collection of cleaned fluid. The third solids outlet 830 may be connected to the waste bin 300, another waste bin 301, and the solids may be transported by the solids moving device 310, or the solids from the dynamic settling centrifuge 800 may be manually extracted from the third solids outlet 830. If the slurry requires recycling, the slurry outlet 820, which is fluidly connected to the second inlet 620 of the second manifold 600, is recycled through the agitator tank 400 to go through the processes as described above.

Preferably, the dynamic settling centrifuge 800 utilizes spiral plate technology for the separation of ultra-find solids from a slurry. Spiral plate technology typically consists of two plate packs, with 90 plates each, spinning on a vertical axis at 4200 rpm. It creates an artificial gravity of over 3000 g. This technology has been found to provide the system 100 with exceptional separation efficiency of fine solids from contaminated fluid.

### Alternate Embodiments

In an alternate embodiment of the system 100, the inlet 475 of the agitator tank 400 could be adapted to intake fluid or slurry S in need of only small gravity solids removal. Advantageously, the system 100 can quickly be adapted to bypass the vertical cuttings dryer 260/first stage and allow quick and targeted treatment of contaminated slurry S.

Advantages

The invention of the three phase process disclosed herein has many benefits compared to the current industry standard practice. The phases combined as described in this disclosure allow for fluid to be recaptured that would otherwise be lost when the cuttings coming off a shaker are disposed of in a drill site setting.

Furthermore, the solid by-products that result from the disclosed process have a significantly reduced volume compared to the saturated cuttings off the shaker. This results in less landfill usage, less chemicals on the solids being placed in the landfill and less money and time spent emptying the waste bins/transporting the waste. In addition, the solids from waste bin are of a consistency that they can be used to replace sawdust in other drill site operations where fluid/sludge needs to be absorbed. This results in extra efficiencies and cost savings.

The proposed arrangement of the invention, to be assembled on a truck's flatbed, provides for a relatively low footprint on the rig site for such advanced processing capabilities as well as the ability to only bring the equipment on site as needed and with short notice.

The closed system nature of all three phases, including the provisioning for vacuum systems and pumps that can intake the cuttings reduces the drill site's reliance on heavy machinery such as excavators that would otherwise be needed to move around and mix the cuttings output by the shaker.

Those of ordinary skill in the art will appreciate that various modifications to the invention as described herein will be possible without falling outside the scope of the invention. In the claims, the word “comprising” is used in its inclusive sense and does not exclude other elements being present. The indefinite article “a” before a claim feature does not exclude more than one of the features being present.

What is claimed is:

1. A system for capturing and cleaning fluid comprising:
a vertical cuttings dryer for separating solids from a slurry comprising an inlet for accepting a slurry from a slurry moving apparatus, a slurry outlet, a first solids outlet, and a waste bin fluidly connected to the first solids outlet, the slurry outlet accommodating the slurry from the vertical cuttings dryer, the first solids outlet accommodating extraction of solids from the vertical cuttings dryer to the waste bin;
an agitator for mixing and heating slurry comprising, a slurry inlet fluidly connected to the slurry outlet of the vertical cuttings dryer for accepting the slurry from the vertical cuttings dryer through a second slurry moving apparatus, an impeller for mixing the slurry, and a heating plate for heating the slurry, a clean base fluid inlet for accepting uncontaminated fluid from a clean base fluid holding tank for mixing with the slurry, a feedback inlet for accepting slurry therein, a slurry outlet accommodating the slurry from the agitator, a first flow meter/densitometer for measuring the flow rate and density of the slurry having an inlet fluidly connected to the slurry outlet and an outlet fluidly connected to an inlet of a first manifold, the first manifold having multiple outlets for directing the slurry downstream, a clean fluid tank fluidly connected to a third outlet of the first manifold for accepting clean fluid therein;
a decanter centrifuge for separating solids from a slurry comprising a decanter inlet fluidly connected to a first outlet of the first manifold for accepting the slurry from the agitator, a slurry outlet fluidly connected to the feedback inlet of the agitator for accommodating removal of the slurry from the decanter centrifuge to be cycled back through the agitator, a second solids outlet for accommodating extraction of solids from the decanter centrifuge to the waste bin.
a dynamic settling centrifuge for separating solids from a slurry comprising a dynamic settling centrifuge inlet fluidly connected to a second outlet of the first manifold for accepting the slurry from the agitator, a first slurry outlet fluidly connected to the feedback inlet of the agitator for accommodating removal of fluid from the dynamic settling centrifuge to be cycled back through the agitator, a third solids outlet for accommodating extraction of solids from the dynamic settling centrifuge to the waste bin;
the first flow meter/densitometer measures the slurry, if the slurry contains solids greater than a first pre-determined condition, the first manifold provides a flow path for the slurry to the decanter centrifuge for a pre-determined cycle wherein solids are removed and the slurry is reintroduced to the agitator, if the slurry contains solids less than the first pre-determined condition but greater than a second predetermined condition, the first manifold provides a flow path for the slurry to the dynamic settling centrifuge for a pre-determined cycle wherein solids are removed and the slurry is reintroduced to the agitator, if the slurry contains solids less than the second pre-determined condition, the first manifold provides a flow path for the slurry to the clean fluid tank.

2. The system of claim 1 further comprising a second flow meter/densitometer having an inlet fluidly connected to the outlet of the second manifold for measuring the flow rate and density of the slurry.

3. The system of claim 2 further comprising a flow control system comprising the first and second flow meters/densitometers for measuring fluid flow, and multiple valves placed throughout the system for regulating flow, for synchronizing the flow rate of the slurry throughout the system.

4. The system of claim 2 wherein the flow control system is manually or remote controlled.

5. The system of claim 2 wherein the flow control system is automatically controlled, the flow control system comprising a processor having a computer input where preset limitations are entered for receiving input from the multiple flow meters/densitometers of the flow control system and the processer producing an output to the multiple valves placed throughout the system for regulating flow.

6. The system of claim 1 wherein the first phase slurry moving apparatus further comprises a pump, a hopper connected to the pump for accepting the slurry, and an outlet fluidly connected to the inlet of the vertical cuttings dryer.

7. The system of claim 1 wherein the first phase slurry moving apparatus further comprises a cyclone vacuum system having a cyclone cylinder and a vacuum motor having an exhaust for accepting the first phase slurry, and an outlet fluidly connected to the inlet of the vertical cuttings dryer.

8. The system of claim 1 wherein the exhaust from the first phase slurry moving apparatus is captured and used as a heat source for the heating plate.

9. The system of claim 1 further comprising a solids moving device connected to the first solids outlet and the second solids outlet for transporting solids to the waste bin.

10. The system of claim 1 further comprising a second manifold having multiple inlets and one outlet, the multiple inlets comprising a first inlet fluidly connected to a fourth outlet of the first manifold, a second inlet fluidly connected to the fourth phase slurry outlet, a third inlet fluidly connected to the first slurry outlet, the outlet fluidly connected to the feedback inlet.

11. The system of claim 1 wherein the outlet of the first phase slurry moving apparatus is fluidly connected to the clean base fluid inlet for the agitator to accept the slurry directly.

12. The system of claim 1 wherein the dynamic settling centrifuge further comprises a second slurry outlet fluidly connected to the inlet of the clean fluid tank.

13. A method for cleaning fluid comprising:
collecting a first phase slurry from an industrial process in a vertical cuttings dryer;
separating solids from the first phase slurry within the vertical cuttings dryer and creating a second phase slurry therein;
transferring the second phase slurry to an agitator;
heating and mixing the second phase slurry within the agitator and creating a third phase slurry;
extracting the third phase slurry from the agitator;
measuring the density and flow rate of the third phase slurry as it is extracted from the agitator;
determining the flow path of the third phase slurry based on the predetermined criteria and upon the measured density of the third phase slurry;
transferring the third phase slurry to either a decanter centrifuge for separating solids from the slurry, a dynamic settling centrifuge for separating solids from a slurry, or a clean fluid tank in accordance with the predetermined criteria;

14. A system for cleaning a first slurry contaminated with solids, the system comprising:
a vertical cuttings dryer for removing at least some solids from the first slurry and generating a second slurry;
an first tank for accepting the second slurry and treating said second slurry to generate a third slurry;
a first centrifuge for accepting the third slurry, for removing some solids from said third slurry and for generating a fourth slurry;
a second centrifuge for accepting the third slurry, for removing some solids from said third slurry and for generating a fifth slurry;
a second tank for accepting the third slurry;
a first manifold for accepting the third slurry from the first tank and directing said third slurry to one or more of the first centrifuge, the second centrifuge or the second tank; and
a second manifold for accepting one or both of the fourth slurry from the first centrifuge, or the fifth slurry from the second centrifuge.

15. The system of claim 14, wherein the first centrifuge is a decanter centrifuge and the second centrifuge is a dynamic settler centrifuge.

16. The system of claim 14, wherein the second slurry in the holding tank is treated using one or more of the following: agitation of the second slurry using an agitator, dilution of the second slurry with a clean base fluid, heating of the second slurry using heat, and mixing of the second slurry with one or both of the fourth slurry or fifth slurry.

17. The system of claim 16, wherein the first centrifuge is suitable to remove solids from a slurry that are 8 microns or larger, and wherein the second centrifuge is suitable to remove solids from a slurry that larger than 0.25 microns.
